(19) United States
(12) Patent Application Publication
(10) Pub. No.: US 2023/0280099 A1
(43) Pub. Date: Sep. 7, 2023

(54) ENGINE ROOM DUST CONTROL SYSTEM FOR FRUIT AND VEGETABLE STORAGE FACILITIES

(71) Applicant: Heath Rush, Wenatchee, WA (US)

(72) Inventor: Heath Rush, Wenatchee, WA (US)

(21) Appl. No.: 17/686,005

(22) Filed: Mar. 3, 2022

(51) Int. Cl. F28C 1/16; F28F 27/00; A23B 7/04

(52) U.S. Cl. CPC F28C 1/16; F28F 27/003; A23B 7/04; F28C 2001/006

(57) ABSTRACT

In an engine room associated with fruit and vegetable storage refrigeration facilities, a water return pipe or pipes from a refrigeration cooling tower or towers associated with the engine room terminating below the surface of the water in an engine room water tank which contains highly mineralized water.

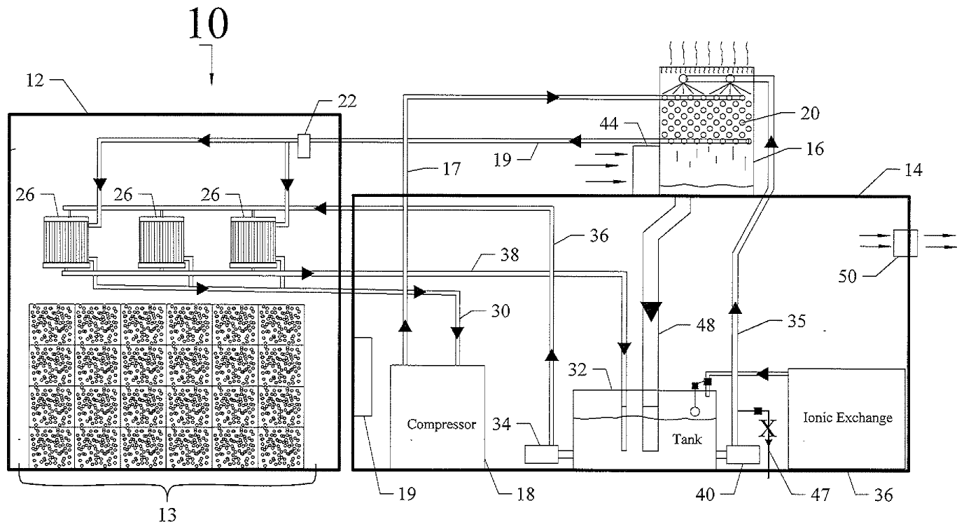

### TECHNICAL FIELD

This invention relates generally to fruit and vegetable refrigeration facilities and more particularly concerns the engine room portion of fruit and vegetable refrigeration facilities.

### BACKGROUND OF THE INVENTION

Fruits and vegetables are typically stored in refrigeration facilities prior to shipment to distribution centers and then to retail locations. A refrigeration facility typically includes a storage unit for the fruits and vegetables which is maintained at a selected temperature range, for example 29°−35° F. The facility also includes an engine room for maintaining the storage facility at the selected temperature range. The engine room includes refrigeration compressors and associated refrigeration cooling towers. The engine room also includes control panels for the operation of the storage facility and a tank of soft water which is highly mineralized. Water from the water tank is in operation pumped up to the refrigeration cooling towers, moves through refrigeration units, usually in the form of refrigerant containing tubes and then down pipes back into the water tank, where it splashes onto the surface of the water in the tank, resulting in a watery mist which is carried over the sides of the tank and into the engine room by air pressure from the cooling tower fans and engine room exhaust fans. As the mist evaporates in the engine room, a dust residue results, which then spreads throughout the engine room. The dust is harmful to the electrical components of the engine room, including the compressors and pump motors as well as the system control panel elements.

Accordingly, it would be desirable to significantly reduce or eliminate the mist created by the returning water from the cooling tower so as to reduce the dust in the engine room remaining after the mist evaporates.

### SUMMARY OF THE INVENTION

Accordingly, the present invention is an engine room dust control system for use with fruit and vegetable storage refrigeration facilities, wherein the engine room includes a tank containing mineralized water and an associated refrigeration cooling tower, wherein the dust control system includes a return pipe or pipes from the refrigeration cooling tower or towers having an open lower end which extends below a surface of the mineralized water therein during operation of the engine room, such that little or no mist is produced by action of water returning from the cooling tower into the mineralized water in the water tank, thereby eliminating any mist being carried into the engine room by air movement in the engine room, reducing dust which would otherwise be produced when the mist would evaporate.

### BRIEF DESCRIPTION OF THE DRAWINGS

The FIGURE is a schematic block showing a storage refrigeration facility, including the arrangement of the present invention in the engine room portion of the facility.

### BEST MODE FOR CARRYING OUT THE INVENTION

A refrigeration facility is generally shown at 10 in the FIGURE. The refrigeration facility includes a storage unit shown representationally at 12 into which is stored fruit and/or vegetables in bins 13 of various sizes. Associated with the storage unit 12 is an engine room 14, and refrigeration cooling towers 16 associated with the engine room 14, usually located on top of the engine room 14. The engine room 14 includes a refrigeration compressor or compressors 18 and a control panel or panels 19 for operational control. Refrigeration compressors 18 in operation produce a stream of high pressurized hot gas which is directed through line 17 to the refrigeration cooling towers 16 which includes a plurality of refrigerant tubes, shown collectively at 20. The hot gas directed to the cooling tower 16 is cooled, becomes liquefied and is directed from the cooling tower 16 to the storage unit 12 through line 19. The liquid under high pressure enters the storage unit, moving through a pressure relief system 22, becoming a very cold gas. This cold gas is then directed to a series of evaporator units 26-26. The number of evaporator units 26-26 can vary and are typically located at the top of the storage unit. They absorb a significant amount of heat present in the storage unit, maintaining the temperature in the storage unit, in a typical arrangement, between 29° and 35° F. The gas from the evaporator units is then returned to compressors 18 through line 38, to repeat the cycle. Frost has typically formed on the evaporation units in operation.

A typical storage refrigeration facility will include two water circulation systems. Engine room 14 contains a water storage tank 32 which contains a quantity of water. In one water circulation system, defrost pumps 34 periodically pump water from storage tank 32 through water lines 36 up and over the evaporator units 26-26 for removal of frost which has accumulated in operation on the evaporator units 26-26. The defrost water is then returned in pipe 38 to water tank 32.

A second water circulating system includes cooling tower pumps 40 that pump water from tank 32 up to the refrigeration cooling towers 16, returning to tank 32 via pipe 48. In this invention the water supply for tank 32 is a well-known ionic exchange system 36 producing softened, ground water that contains minerals. As indicated above, the soft tank water is pumped up and over the hot refrigerant tubes 20 in the refrigeration cooling towers 16. Pure water is evaporated out of the cooling tower assisted by action of fans 44. The more concentrated mineralized water falls into cooling tower sump 46 and returned to tank 32 through large pipe 48. Without the traditional bleed 47 of the tank water required by the usual chemical treatment system, the minerals in the water in tank 32 concentrate to a high level. The highly mineralized water has a pH greater than 9, which kills animal and plant life that are problems with refrigeration storage systems. Furthermore, the naturally occurring silica level in the water is concentrated enough to protect metal surfaces from corrosion. In the present invention, the return pipe or pipes 48 which normally ends above the surface of the water in tank 32, extends downwardly below the surface of the water, approximately 2 feet in the embodiment shown. Consequently, there is both no splashing from returning water and no mist created by the splashing, which would otherwise by carried over the sides of the tank 32 and into the engine room by air movement in pipes 48 and the engine room and exhaust fan 50. Since there is no mist escaping from the tank, moving into the engine room with the present invention, there is no mineral dust which would otherwise be present when that mist would evaporate in the engine room. This desirably solves the problem of dust formation in the engine room.

Accordingly, the specific arrangement of the return pipe or pipes extending below the level of the highly mineralized water in tank 32 significantly reduces or eliminates the possibility of dust in the engine room.

Although a preferred embodiment of the invention has been disclosed for purposes of illustration, it should be understood that various changes, modifications and substitutions can be included in the system without departing from the spirit of the invention, which is defined by the claims which follow.

What is claimed is:

1. An engine room dust control system for use with fruit and vegetable storage refrigeration facilities, wherein the engine room includes a tank containing mineralized water and an associated refrigeration cooling tower, wherein;
the dust control system includes a return pipe or pipes from the refrigeration cooling tower or towers having an open lower end which extends below a surface of the mineralized water therein during operation of the engine room, such that little or no mist is produced by action of water returning from the cooling tower into the mineralized water in the water tank, thereby eliminating any mist being carried into the engine room by air movement in the engine room, reducing dust which would otherwise be produced when the mist would evaporate.
